(19) United States
(12) Patent Application Publication
(10) Pub. No.: US 2005/0210369 A1
(43) Pub. Date: Sep. 22, 2005

(54) Methods of updating spreadsheets

(76) Inventor: John A. Damm JR., Los Altos, CA (US)

Correspondence Address: PETER K HAHN;LUCE, FORWARD, HAMILTON, SCRIPPS, LLP., 600 WEST BROADWAY, SUITE 2600, SAN DIEGO, CA, 92101, US

(21) Appl. No.: 10/804,271

(22) Filed: Mar. 18, 2004

(51) Int. Cl. G06F 9/455

(52) U.S. Cl. 715/503

(57) ABSTRACT

The present invention provides methods of updating spreadsheet-based cells. One method of updating spreadsheet-based cells involves tapping on a cell and automatically increasing the value of the cell by a predetermined increment each time the cell is tapped. Another method of updating spreadsheet-based cells involves tapping on a cell, automatically displaying a drop-down list in response to tapping on the cell, tapping on a cell value to select a new cell value and automatically entering the new cell value into the cell.

### FIELD OF THE INVENTION

The present invention is directed to methods of updating spreadsheets, and more particularly to methods of updating spreadsheet-based cells using a tap-counting feature and a cell-based drop down list feature.

### BACKGROUND OF THE INVENTION

Electronic spreadsheets organize data into a matrix comprising many distinct units called cells. Each cell stores a data element, which may draw on data elements from other cells to calculate its value. When using a spreadsheet on a handheld computer, cells are usually selected by tapping a cell directly on the screen. The selected cell may be displayed with a dark border or other visual indication. After selecting a cell, subsequent commands are applied to the selected cell. Typical spreadsheet programs allow a user to select one or more cells for manipulation. For example, the cell may be copied, duplicated, deleted, moved to a new location, etc.

One disadvantage of such spreadsheets is that they require a user to go through several time consuming steps before the cell manipulation is actually carried out. In addition, prior art systems usually require a user to be familiar with a variety of spreadsheet functions in order to effectively use the software. For example, most spreadsheets require both a tap on the target cell and the entry of an amount. To perform a process such as tap counting, a user must tap on the target cell, then renter a new value for that cell, which may require a mental calculation of the new value. This process is especially cumbersome when working on a handheld computer.

Some spreadsheets permit the placement of controls such as buttons and drop-down lists to facilitate processes such as tap counting. However, these spreadsheets typically require programming code (such as Visual Basic) to make the connection between the control and a particular cell. Many users feel that the programming code is confusing and cumbersome.

In view of the above, there exists a need for improved methods of manipulating spreadsheet-based cells on handheld computers.

### SUMMARY OF THE INVENTION

The present invention provides improved methods of manipulating spreadsheet-based cells on a computer. In particular, a method of manipulating spreadsheet-based cells on a handheld computer using a tap-counting feature and a method of manipulating spreadsheet-based cells on a handheld computer using cell-based drop-down lists are provided. These methods may be implemented as part of a computer software application that includes machine-readable instructions for carrying out the methods, for example using a handheld computer such as a palm pilot.

One aspect of the present invention involves a method of updating a spreadsheet-based cell by tapping on the cell and automatically increasing the value of the cell by a predetermined increment each time the cell is tapped. The step of tapping on the cell is performed by a person using a stylus and the step of automatically increasing the value of the cell by a predetermined increment is performed by a computer.

Another aspect of the present invention involves a method of updating a spreadsheet-based cell having a cell-based drop-down list, the drop-down list including a plurality of alternative cell values. The method includes the steps of tapping on the cell, automatically displaying the drop-down list in response to tapping on the cell, tapping on one of the alternative cell values to select a new cell value and automatically entering the new cell value into the cell. The steps of tapping on the cell and tapping on one of the alternative cell values are performed by a person using a stylus and the steps of automatically displaying the drop-down list and automatically entering the new cell value are performed by a computer.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a top view of a handheld computer suitable for running the spreadsheet software of the present invention;

FIG. 2 is a top view of the handheld computer of FIG. 1 depicting a list of saved spreadsheet files;

FIGS. 3 and 4 are top views of the handheld computer of FIG. 1 depicting a spreadsheet file having cells that feature tap-counting;

FIGS. 5 and 6 are top views of the handheld computer of FIG. 1 depicting a spreadsheet file having cells that feature cell-based drop-down lists; FIGS. 7 and 8 are top views of the handheld computer of FIG. 1 depicting the use of the pause button;

FIGS. 9 and 10 are top views of the handheld computer of FIG. 1 depicting the creation of a new spreadsheet; and

FIGS. 11A-11C are schematic diagrams depicting a method of manipulating spreadsheet-based cells on a handheld computer according to the principles of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The methods of updating spreadsheets of the present invention preferably are implemented as part of a computer software application that includes machine-readable instructions for carrying out the methods disclosed herein. The software preferably is installed onto a handheld computer such as a palm pilot having a touch screen that utilizes a stylus to input user commands and data entry. Alternatively, the software may be installed onto a personal computer or laptop. The software works like a conventional spreadsheet having a matrix of rows and columns of information. For example, columns may be user-programmed to define formulas that may include references to other columns, numbers and standard arithmetic operations.

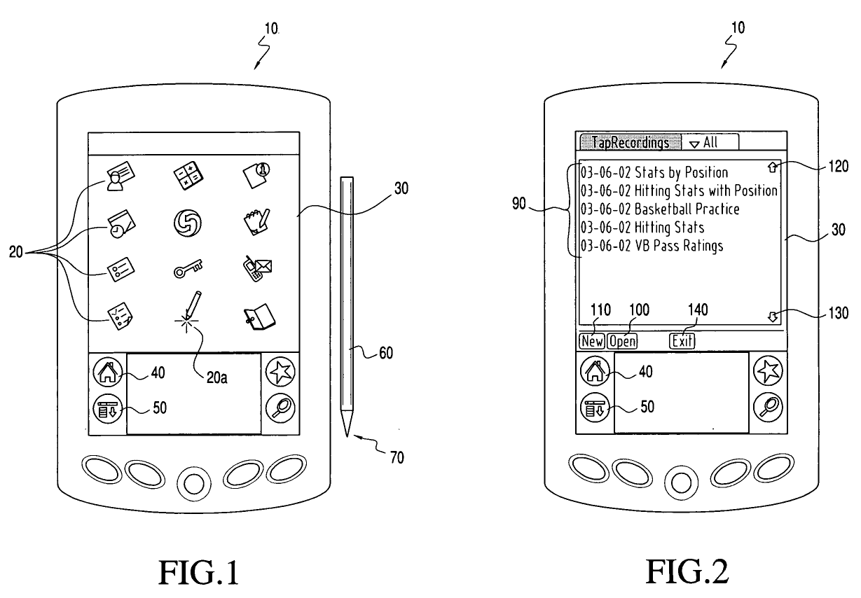

Referring to FIG. 1, a handheld computer 10 is depicted having a plurality of software applications, which appear as icons 20 on a screen 30. Icon 20a is used to access the tap-counting and cell-based drop-down list files of the present invention. An application icon 40 and a menu icon 50 are provided as part of the handheld computer and its operating system. These buttons are not an aspect of the software program of the present invention. Data entry is performed using a stylus 60, which includes a tapered end 70 for tapping the touch-based application screens. Alternatively, if the software is installed onto a personal computer or laptop, a computer mouse may be used to click a selected cell rather than using the stylus to tap on the selected cell. According to some embodiments, certain types of data entry are performed using an on-screen keyboard or an add-on keyboard. The computer mouse, on-screen keyboard and add-on keyboard are per se known in the art.

To begin using the tap-counting and cell-based drop-down list software, a user employs stylus 60 to tap on application icon 40 to access the applications, then taps on icon 20a. Alternatively, a computer mouse may be used to click on the application icon. The user may also tap on menu icon 50 to select and perform various application-defined menu tasks. Referring to FIG. 2, when the application starts up, a list of saved files 90 is displayed on screen 30. To use an existing file, the user taps on the appropriate file, then taps on the “Open” button 100. To create a new file, the user taps on the “New” button 1 10. “Up” and “Down” scrolling symbols 120, 130 and an “Exit” button 140 for returning to main screen are also provided.

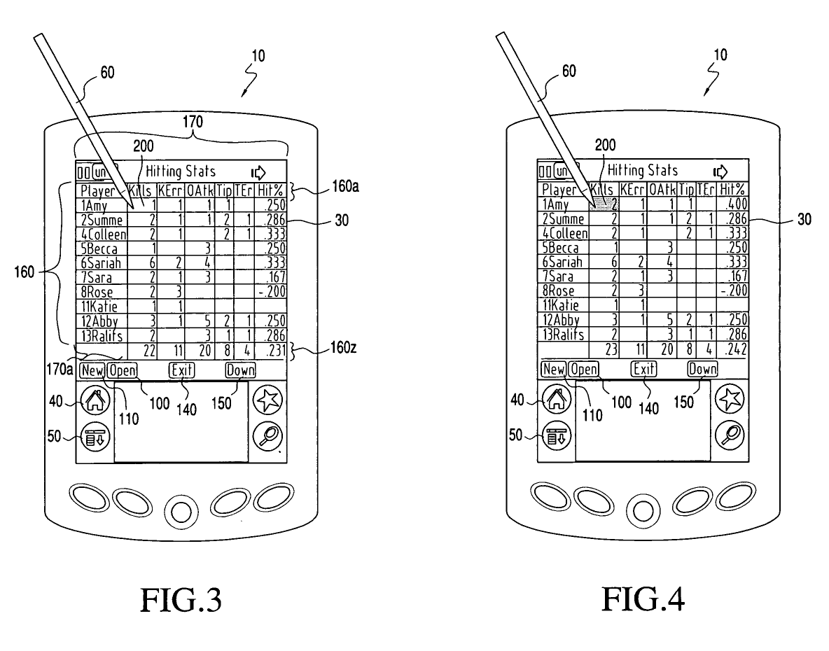

Referring to FIG. 3, the user has opened a file called “Hitting Stats” from the list of saved files 90 by tapping on the appropriate entry, then tapping on the “Open” button. The selected entry comprises a spreadsheet including a matrix of rows 160 and columns 170. The first column 170a comprises a list of players including Amy, Summuer, Colleen, Becca and other volleyball participants. Additionally, the first row 160a comprises column headers for each column, and the last row 160z comprises column totals for each column. Some columns are adapted for tap counting for recording the number of times a particular cell has been tapped using stylus 60, and other columns include cells that are adapted to provide drop-down lists. In the illustrated embodiment, a volleyball statistics file for recording hitting performance includes columns 170 for kills, attack errors, tips, hitting efficiency and other common volleyball statistics.

In the current example, a user is recording statistics at a volleyball match that includes the participants identified in first column 170a. When Amy scores a “kill”, the user records the score by tapping (or clicking) on cell 200, which is defined by the intersection of Amy's row and the kills column. In response, the software automatically increments cell 200 by a predetermined increment value of 1. Thus, as depicted in FIG. 4, Amy's kills have increased from 1 to 2. In addition, Amy's Hit% is updated automatically in response to the increase in kills.

By contrast, the user of a typical handheld computer spreadsheet would have to tap on the cell to select it, then enter the appropriate value via a keyboard or other input device. Further, the user must press enter or otherwise indicate that they are finished editing the cell. Advantageously, the tap-counting software of the present invention only requires a single tap (or click) to achieve the same result. Preferably, the predetermined increment value can be set to any other tangible amount, including a negative value. By way of example, for a basketball scoring application, the predetermined increment value would be 2 for Field Goals, 3 for 3-Point Field Goals and 1 for Free Throws.

According to an alternative tap-counting embodiment, the software is adapted for voice recognition instead of sensing taps on the screen. For example, a user identifies the appropriate row by saying “Player 5”, then identifies the appropriate column by saying “Field Goal”. In response, the software automatically adds the predetermined increment to the selected cell (i.e. the tap counter adds two points to player 5 under the Field Goal column).

According to another aspect of the present invention, cell-based drop-down lists are provided. These cell-based drop-down lists associate a traditional drop-down list box, per se known in the art, with a specific cell. In particular, when a user taps (or clicks) on cell, a drop-down list of alternative choices is presented. Selection of one of the alternative choices by tapping on the selection causes that value to be entered into the cell automatically. By contrast, the user of a typical handheld computer spreadsheet would have to tap on the cell to select it, then enter the appropriate text characters and/or numbers via a keyboard or other input device. In addition, the user must press enter or otherwise indicate that they are finished editing the cell. Advantageously, the cell-based drop-down lists of the present invention only requires two taps to achieve the same result. The first tap selects the cell and causes the drop-down list to appear. The second tap selects the entry for this cell. Once an entry has been selected from the drop-down list, the selected cell contains the associated text and can be accessed like any other spreadsheet cell.

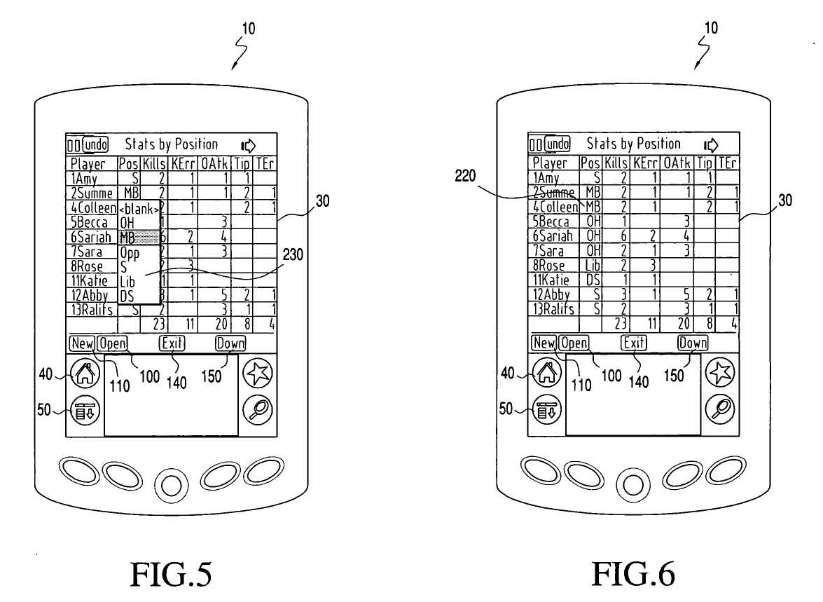

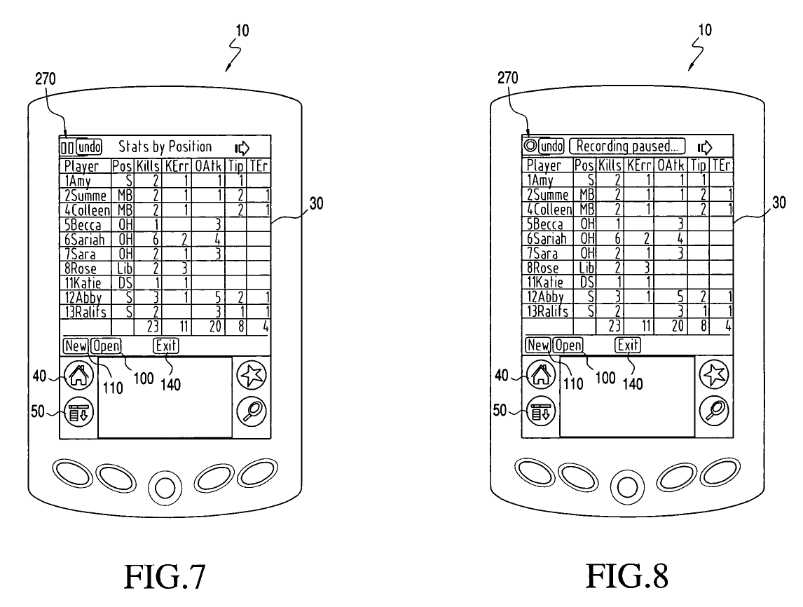

Referring to FIGS. 5-6, the user has opened a spreadsheet called “Stats by Position” from the list of saved files 90 by tapping on the appropriate spreadsheet, then tapping on the “Open” button 100, as described above with respect to FIG. 2. The “Stats by Position” spreadsheet is a volleyball statistic spreadsheet for recording volleyball statistics by position. The second column, “Pos”, contains cells that include a drop-down list 230 containing different volleyball player positions. To mark or change a player position, the user taps on the appropriate cell for the player in the “Pos” column, then taps on the proper player position from drop-down list 230. For example, to change Colleen's position to middle blocker (“MB”), the user taps on cell 220, which is defined by Colleen's row and the “Pos” column, then taps on the “No” from drop-down list 230.

According to some embodiments of the present invention, a drop-down list is provided comprising subjective ratings of player performances. Some choices on the drop-down list may include “excellent”, “above average”, “good”, “fair” and “poor”. According to other embodiments, drop-down lists are provided comprising sizes of equipment issued and types of equipment used. As would be understood by those of ordinary skill in the art, the examples provided herein are merely exemplary, and many alternative drop-down lists are conceivable without departing from the scope of the present invention.

Additional features of the software include check mark columns, data entry columns and calculation columns. Check mark columns contain cells that feature check marks. The first tap on such a check mark cell causes a check (e.g., an “x”) to appear in that cell. The second tap on the check mark cell causes the check to disappear. One suitable use for check mark columns is for taking daily attendance. Data entry columns can be set up for the entry of text, numeric, date and time data into cells. The data can be entered using an on-screen keyboard or an add-on keyboard, both of which are per se known in the art. Calculation columns include formulas, which may include references to other columns. For example, column 1 (C1) of a spreadsheet file contains field goals attempted for a group of players and column 2 (C2) contains field goals made for this group. Column 3 (C3), field goal %, can be created by entering the formula C2/C1 into a formula field.

Referring to FIGS. 7 and 8, according to some embodiments, screen 30 includes a pause button 270 for switching between recording and pause modes. In the recording mode, each tap in a cell increases the tap count, opens a drop-down-list or causes a prompt for text entry. However, to accomplish other tasks (e.g., highlighting a range of cells to be copied), the user taps on the pause button, thereby causing “Recording paused” to appear on the screen. A subsequent tap on pause button 270 resumes the recording mode. In the paused mode, the user may highlight cells for conventional spreadsheet manipulation (e.g., copying, pasting, erasing, etc.).

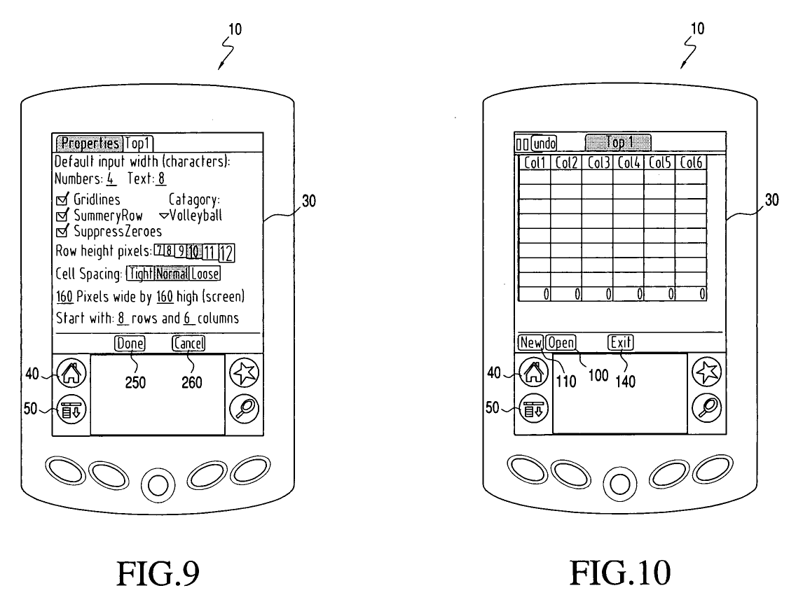

Methods of creating new tap-counting and cell-based drop-down list files that are tailored to the user's specific needs will now be described with respect to FIGS. 9 and 10. To create a new spreadsheet, the user taps on the “New” button 110 (see FIGS. 2 through 7). Referring to FIG. 9, the user is then prompted to set up the initial application properties, such as including the title, default column widths, initial number of rows and columns, and other application properties. The user is then prompted to tap on the “Done” button 250 to proceed (or the cancel button 260 to return to the main screen). In the illustrated embodiment, the user has selected an application containing 8 rows and 6 columns. Referring to FIG. 10, once the properties have been set up for the file, the user enters the row and column headings by: (1) tapping on the row or column heading; and (2) entering the appropriate data using an on-screen keyboard or an add-on keyboard.

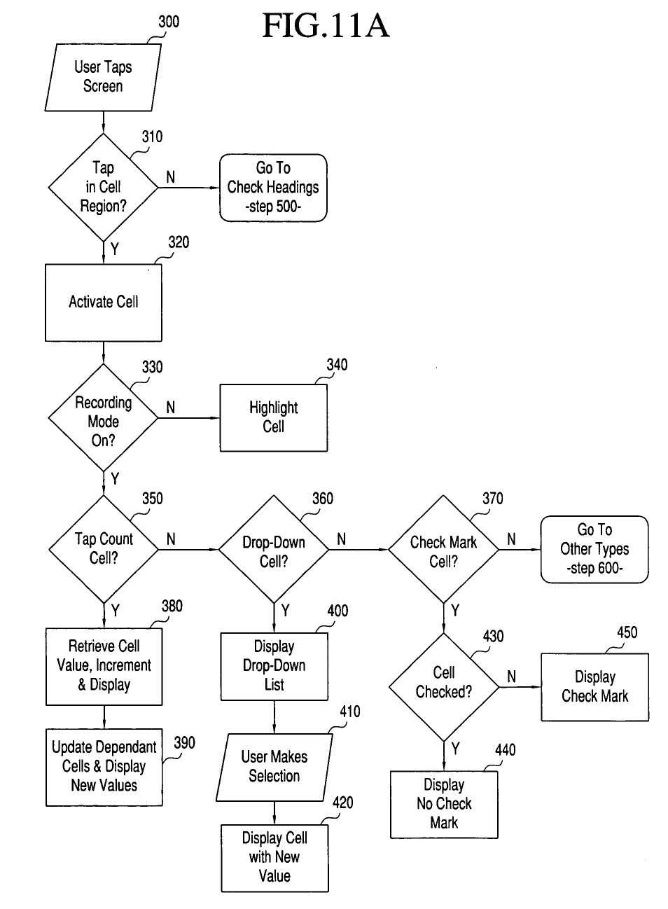

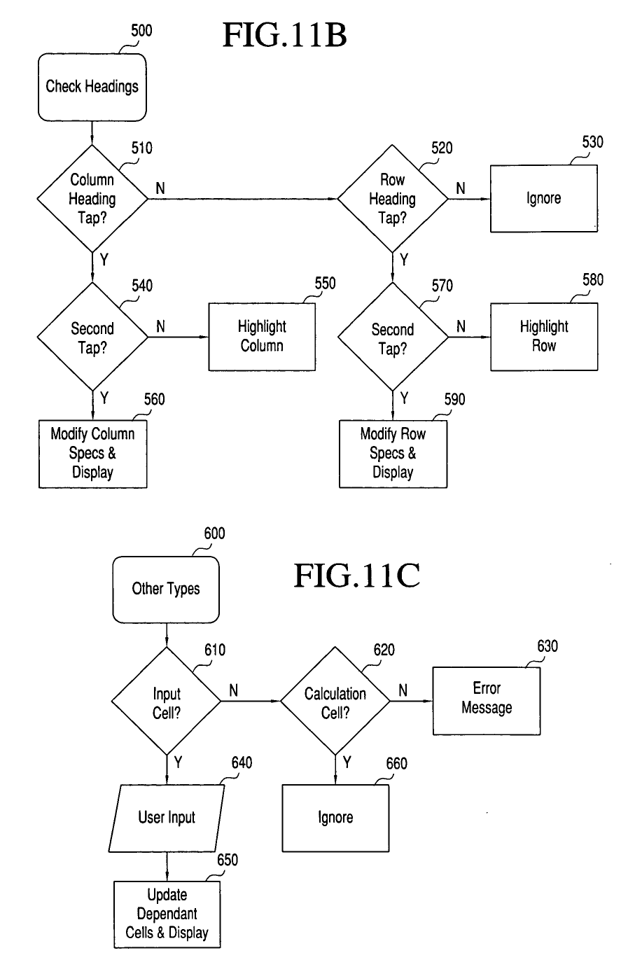

A method of manipulating spreadsheet-based cells using the software of the present invention will now be described with respect to the flowchart depicted in FIGS. 11A-11C. The method features tap-counting, cell-based drop-down lists, check mark cells, row and column headings, input cells and calculation cells. Referring to FIG. 11A, at step 300 the user taps the screen in the area of the spreadsheet. In response, the software checks if the tap occurred within a cell region (as distinguished from the row and column heading areas) (step 310).

If the tap is not in a cell region, the software proceeds to step 500 to check for row or column heading taps (see FIG. 11B). If the tap is within a cell region, the software activates the cell by saving the row and column position of that specific cell (step 320). According to a preferred embodiment, the spreadsheet includes a recording mode for entering data and a paused mode, wherein cells can be highlighted for conventional manipulation such as copying, pasting and erasing. At step 330, the software checks whether the spreadsheet is in the recording mode or the paused mode.

Referring to step 340, if the spreadsheet is in paused mode, the cell is highlighted and the software waits for subsequent taps. On the other hand, if the spreadsheet is in the recording mode, the software checks the type of the cell in the following manner. First, it checks whether the selected cell features tap-counting (350). If the selected cell does not feature tap-counting, the software checks whether the selected cell features a drop-down list (step 360). If the selected cell does not feature a drop-down list, the software checks whether the selected cell is a check mark cell (step 370). If the selected cell is not a check mark cell, the method proceeds to step 600 to check for other cell types (see FIG. 11C).

Referring again to step 350, if the software determines that the selected cell features tap-counting, the method proceeds to step 380, wherein the software retrieves the current cell value, adds the predetermined increment value to the current cell value, and displays the new value. The software then updates all cells which depend on this cell (i.e., refer to it in formulas), displays the new values and waits for subsequent taps (step 390).

Referring again to step 360, if the software determines that the selected cell features a drop-down list, the method proceeds to step 400, wherein the software displays a drop-down list containing more than one value. Preferably, the currently selected value is highlighted during step 400. Next, the user selects one of the values from the drop-down list by tapping on the appropriate value (step 410). In response, the software displays the selected value in the cell and waits for subsequent taps (step 420).

Referring again to step 370, if the software determines that the selected cell is a check mark cell, the method proceeds to step 430, wherein the software checks whether the selected cell contains a check mark. If the cell contains a check mark, the method proceeds to step 440, wherein the software removes the check mark from the cell such that no check mark is displayed and waits for subsequent taps. Contrariwise, if the cell does not contain a check mark, the method proceeds to step 450, wherein the software displays a check mark within the cell and waits for subsequent taps.

Referring to FIG. 11B, when the user's initial tap is not in a cell region, the software proceeds to step 500 to check for row or column heading taps. At step 5 10, the software determines whether the user's tap is within a column heading. If the tap is not in a column heading, the software determines whether the tap is within a row heading (step 520). If not, the software ignores the initial tap and waits for subsequent taps (step 530). If the tap is in a row heading, the software checks for a second tap in the row heading (step 570). If no second tap is detected, the software highlights the row containing the selected cell and waits for subsequent taps (step 580). If a second tap is detected, the software displays a screen adapted to permit editing of the row heading (step 590).

Referring again to step 510, if the software determines that the initial tap is within a column heading, the method proceeds to step 540, wherein the software checks for a second tap in the column heading. If no second tap is detected, the software highlights the column and waits for subsequent taps (step 550). If a second tap is detected, the software displays a screen adapted to permit editing of the column heading (step 560).

Referring to FIG. 11C, when the initially selected cell does not feature tap-counting, drop-down lists or check marks, the method proceeds to step 600 to check for other cell types. At step 610, the software checks whether the selected cell is an input cell. If not, the software checks whether the cell is a calculation cell (step 620). If the cell is not a calculation cell, an error message is displayed (step 630). If the cell is a calculation cell, the software ignores the tap and waits for subsequent taps (step 660).

Referring again to step 610, if the selected cell is an input cell, the method proceeds to step 640, wherein the user inputs a new value into the selected cell. In response, the software updates dependent cells that involve the selected cell, displays the new cell values and waits for subsequent taps (step 650).

Throughout the specification, spreadsheet columns are described as containing cells that are all adapted for a single purpose. For example, some columns contain cells adapted for tap counting, other columns include cells having associated drop-down lists, and still other columns include cells having associated check marks. According to further embodiments, a column may contain cells having different purposes. For example, some cells within the column may be adapted for tap counting, while others have associated drop-down lists or check marks.

Thus, it is seen that methods of manipulating spreadsheet-based cells on a handheld computer are provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

1. A method of updating a spreadsheet-based cell having a value, the method comprising the steps of:
tapping on the cell; and
automatically increasing the value of the cell by a predetermined increment each time the cell is tapped.

2. The method of claim 1, wherein the step of tapping on the cell is performed by a person.

3. The method of claim 1, wherein the step of tapping on the cell comprises the step of tapping on a touch screen using a stylus.

4. The method of claim 1, wherein the step of automatically increasing the value of the cell by a predetermined increment is performed by a computer.

5. The method of claim 4, wherein the computer is a handheld computer.

6. The method of claim 1, further comprising the step of automatically updating the value of other cells whose value depends upon the value of the cell.

7. A method of updating a spreadsheet-based cell having a cell-based drop-down list, the drop-down list including a plurality of alternative cell values, the method comprising the steps of:
tapping on the cell;
automatically displaying the drop-down list in response to tapping on the cell;
tapping on one of the alternative cell values to select a new cell value; and
automatically entering the new cell value into the cell.

8. The method of claim 7, wherein the steps of tapping on the cell and tapping on one of the alternative cell values are performed by a person.

9. The method of claim 7, wherein the steps of tapping on the cell and tapping on one of the alternative cell values comprise the step of tapping on a touch screen using a stylus.

10. The method of claim 7, wherein the steps of auto automatically displaying the drop-down list and automatically entering the new cell value are performed by a computer.

11. The method of claim 10, wherein the computer is a handheld computer.

12. The method of claim 7, further comprising the step of automatically updating the value of other cells whose value depends upon the value of the cell.

13. A method of updating a spreadsheet-based cell having a value, the method comprising the steps of:
clicking on the cell; and
automatically increasing the value of the cell by a predetermined increment each time the cell is clicked.

14. The method of claim 13, wherein the step of clicking on the cell is performed by a person using a computer mouse or other pointing device.

15. The method of claim 13, wherein the step of automatically increasing the value of the cell by a predetermined increment is performed by a personal computer or laptop.

16. A method of updating a spreadsheet-based cell having a cell-based drop-down list, the drop-down list including a plurality of alternative cell values, the method comprising the steps of:
clicking on the cell;
automatically displaying the drop-down list in response to clicking on the cell;
clicking on one of the alternative cell values to select a new cell value; and
automatically entering the new cell value into the cell.

17. The method of claim 16, wherein the steps of clicking on the cell and clicking on one of the alternative cell values are performed by a person using a computer mouse or other pointing device.

18. The method of claim 16, wherein the steps of automatically displaying the drop-down list and automatically entering the new cell value are performed by a personal computer or laptop.
